(19) United States
(12) Patent Application Publication
(10) Pub. No.: US 2023/0183442 A1
(43) Pub. Date: Jun. 15, 2023

(54) METHOD OF DISSOLVING AND RECYCLING THERMOPLASTICS

(71) Applicant: Roland Stefandl, Princeton, NJ (US)

(72) Inventor: Roland Stefandl, Princeton, NJ (US)

(21) Appl. No.: 17/551,795

(22) Filed: Dec. 15, 2021

(51) Int. Cl. C08J 11/20

(52) U.S. Cl. CPC C08J 11/20; C08J 2323/06; C08J 2323/12; C08J 2423/06; C08J 2423/12

(57) ABSTRACT

A method of modifying a polymer or plastic is provided wherein a polymer system, comprising one or more polymer chains, is amorphous, crystalline, semi-crystalline or a combination thereof. The process including exposing the polymer system in a solid, liquid or gas solvent such that the polymer system changes configuration or said polymer changes morphology. The process further comprises subjecting the polymer system to a thermodynamic mechanism such that the Gibbs Free Energy of the polymer system is lowered, the polymer system's entropy is increased, and its chain orientation or morphology is altered.

### FIELD OF THE INVENTION

The present invention relates to the dissolution and recycling of thermoplastic materials.

### BACKGROUND OF THE INVENTION

Solid thermoplastic plastics, such as polypropylene, polyethylene, polystyrene, PET, polyvinylchloride, and other polymers can be melted and re-used. (Thermosets and thermoplastics differ in that a thermoplastic can be melted while a thermoset is a locked solid and re-heating will destroy the chemical bonds and destroy the material's polymer structure. Examples of thermosets that are cross-linked include: urethanes, epoxy, phenol-formaldehyde, and melamines. Thermosets that are not cross linked are very few, and include such materials as Teflon (PTFE—polytetraflouroethylene). Conventionally, chemically crosslinked polymers, known as thermosetting polymers, are difficult to dissolve except when using extremely strong chemicals at high temperature and high pressure.)

The present invention relates to the dissolution of thermoplastics of virtually all types. The morphology of a thermoplastic polymer chain can be crystalline, semi-crystalline or random (amorphous). Polymers with an amorphous morphology have their atoms held together in a loose structure, but this structure is generally not orderly or predictable, which is why skilled chemists will say that amorphous solids have no long-range order. An amorphous polymer chain can be analogous to a piece of cooked spaghetti. The term “amorphous” in polymers can be used for the solid phase polymers (example poly-styrene) or molted thermoplastics that in their solid phase are either crystalline, semi-crystalline or amorphous, but molten polymers have no long-range order and are therefore amorphous.

Almost all thermoplastics fall into one of these categories. When a thermoplastic is in the solid phase it is difficult to dissolve the material/polymer. Once the solid polymer is placed into a solvent, the polymer often prefers to have as its neighbor its own polymer chains of atoms/molecules and remains in the solid phase [CHECK]. A good solvent is one the polymer would prefer over its own molecular chain. The polymer will then un-coil and dissolve into the solvent.

### Thermodynamics of a Thermoplastic Polymer

Much research has been done/published over the decades on polymer-solvent characteristics. When a thermoplastic polymer/plastic is made into usable product/object, it is molded using a specific technology and machinery/equipment such as injection molding, extrusion, and thermoforming, among other techniques known in the art. This process takes the solid virgin polymer, heats the polymer into a melt, forms the shape of the object, then cools it to lock in the final shape of the plastic object. This is the basic process for thermoplastic polymers that are crystalline or amorphous or semi-crystalline.

### Glass Transition Temperature

The glass transition temperature is the temperature above which the polymer chains start to move into a molecular level, and the polymer is no longer stiff or “glass-like.” Above the glass transition temperature the polymer can still be solid, liquid or molten, depending on how high the temperature is above the glass transition temperature of the specific polymer. All different polymers have different glass transition temperatures and melt temperatures. When the polymer is in the melt or molten liquid phase (higher temperature than glass transition) it has no morphological order, no crystallinity, no polymer order; the polymer chain at this temperature is totally random or amorphous. A polymer random chain will easily go into solution with a solvent because one does not need to peel the solid polymer away from itself or from its crystalline structure.

Post-consumer and post industry plastics are disposed of in numerous ways: recycling, landfilling, incineration, composting, and littering and other techniques known in art. There are a number of ways to recycle plastics, and thus it is important to understand the environmental and economical options for recycling post-consumer plastic waste. Presently, waste plastics are being recycled in two main ways: mechanical and chemical recycling. Mechanical recycling involves reprocessing plastic waste to plastic products using physical means. In comparison to chemical recycling, mechanical recycling consumes fewer resources and has a lower impact on global warming. However, the recycled plastic will not have a purity comparable to that of virgin produced plastics. Chemical recycling methods, involve chemically degrading plastics, include two processes that decompose plastic waste into more useful forms: pyrolysis, which involves the thermal degradation of plastics to produce useful liquid products, and gasification which involves heating plastic with air to produce syngas. These two chemical recycling methods result in more useful products and higher purity products, but the processes have a larger environmental impact. An additional chemical recycling method that is the focus of the present invention is the solvent-based mixing of plastics to convert waste plastics into a usable feed to many new polymers and new plastic applications.

Polymer dissolution in solvents is an important area of interest in polymer processing because of its many applications in industry such as microlithography, membrane science, plastics recycling, and drug delivery. Unlike nonpolymeric materials, polymers do not dissolve instantaneously or easily, and the dissolution is controlled by either the disentanglement of the polymer chains or by the diffusion of the chains through a boundary layer adjacent to the polymer-solvent interface. Polymer dissolution becomes important in membrane science, specifically for a technique, called phase inversion, to form asymmetric membranes. In this process, a polymer solution thin film is cast onto a suitable substrate followed by immersion in a coagulation bath (quench step) where solvent/non-solvent exchange and eventual polymer precipitation occur. The final structure of the membrane is determined by the extent of polymer dissolution. Membranes used for microfiltration can be made by exposing a uniform film of crystallizable polymer to an alpha particle beam, causing it to become porous, and the crystalline structure is disrupted. The film is then chemically treated with an etchant, and nearly cylindrical pores are produced with a uniform radius. Another way to produce a microfiltration membrane is to cast films from pairs of compatible, non-complexing polymers. When the films are exposed to a solvent which only dissolves one of the polymers, interconnected microvoids are left behind in the other polymer.

Polymer dissolution also plays an instrumental role in recycling plastics. A single or combined group of solvent can be used to dissolve several unsorted polymers at different temperatures. This process involves starting with a physical mixture of different polymers, usually packaging materials, followed by dissolution of one of the polymers in the solvent at a low temperature. This yields both a solid phase containing polymers which are insoluble in the solvent (at the initial temperature) and a solution phase. The solution phase containing the polymer which dissolved at the low temperature is then drained to separate parts of the system, eventually vaporizing the solvent, leaving behind pure polymer. The solvent is then sent back to the remaining solid phase where it is heated to a higher temperature, another polymer dissolves, and the process is repeated. Several of these cycles are performed at various temperatures until almost all pure, separate purified polymers are obtained.

Polymer dissolution has been of interest for some time and some general behaviors have been characterized and understood throughout the years. The dissolution of non-polymeric materials is different from polymers because they dissolve instantaneously, and the dissolution process is generally controlled by the external mass transfer resistance through a liquid layer adjacent to the solid-liquid interface. However, the situation is quite diverse for polymers. The dissolution of a polymer into a solvent involves two transport processes, namely solvent diffusion and chain disentanglement. When an un-crosslinked, amorphous, solid, glassy polymer is in contact with a thermodynamically compatible solvent, the solvent will diffuse into the polymer. Due to plasticization of the polymer by the solvent, a gel-like swollen layer is formed along with two separate interfaces, one between the glassy polymer and gel layer and the other between the gel layer and the solvent. After time has passed, an induction time, the polymer dissolves.

The importance of crystallinity is that it can affect both diffusivity and solubility. The crystalline structures within a polymer are essentially impenetrable. Therefore, the solvent is only capable of diffusion through the amorphous regions. Also, because of the inability to move into the crystalline regions, the solubility is limited to the amorphous regions. This means that the solubility will depend on the degree of crystallinity with the higher solubilities (on a total weight basis) occurring in polymers that are completely amorphous. This inability of the solvent to travel into the crystals affects the diffusion. The crystalline portions hinder diffusion blocking these pathways, the solvent will have to wind through the amorphous sections of the polymer.

The mechanism of polymer solutions thermodynamically can be viewed into the two stages. Initially the solvent molecules diffuse through the polymer matrix to form the swollen, solvated mass called the gel. In the second stage this gel breaks up and the molecules are dispersed into a true solution. The solution process is defined by its Gibbs free energy:

ΔG=ΔH−T·ΔS
ΔG=Gibbs free energy
ΔH=Change in enthalpy
ΔS=Change in entropy
T=Temperature in K

When a polymer dissolves spontaneously, the Gibbs free energy must be negative. The change in entropy of the solution has a positive value rising from the increase in the conformational mobility of the polymer chains. Likewise, as one increases the temperature of the system this further lowers the Gibbs free energy value.

Crystallinity is the term used to describe long range order at the atomic level within a polymer. A solid polymer can be completely amorphous having no long range order and no crystallinity or have some degree of crystallinity. The degree of crystallinity in a polymer is the percentage of the polymer's volume that is crystalline in ratio to the amorphous section. This is specific to the type of polymer and its monomer construction. Theoretically the degree of crystallinity can range from 0 to 100% in a polymer. Typically for HDPE, the highest obtainable degree of crystallinity is generally around 80%. The degree of crystallinity varies with temperature. When a polymer is heated, its crystalline structure begins to break down as it turns more amorphous.

The polymer melt temperature is an important property. When a polymer is heated above its melt temperature it does not make a transition from a solid to a liquid. Instead, at this temperature, the crystalline structure within the polymer breaks down (not destroying the polymer chain itself) and the material becomes amorphous. This polymer state is total disorder with no crystallinity. This definition for a polymer's melt temperature is much different than a normal material's transition from solid to liquid. The melt temperature should not be confused with the glass transition temperature which is the transition point in a solid plastic. At the glass transition temperature, the plastic solid will change from a glassy rock like hard solid material to a softened, rubbery molecular solid state upon heating to increase its temperature. This represents molecular movement of the individual polymer chains. Below the glass transition temperature, the amorphous solid is hardened with no distinct order which differs from the crystalline structure growth which occurs upon cooling from the melting temperature. The glass transition temperature is lower than the melt temperature.

The melt temperature of a polymer is only relevant for thermoplastics that can be melted and remolded. These polymers can reach their melt temperature before degradation occurs unlike thermosetting polymers that would degrade far before they reached a temperature at which they could melt. Once a thermoplastic reaches above its melt temperatures, crystals within the structure will cease to exist, and the polymer will be a completely amorphous, and without crystalline order. As the polymer is heated further past its melt temperature, it will begin to take on more of the properties of a liquid as the polymer itself begins to soften. This will continue until the polymer will be able to flow slowly as a viscous liquid. If the thermoplastic is heated too far above its melt temperature, thermal degradation will take place, destroying the polymer chains which permanently changes the properties of the polymer. Evidence of this type of degradation is evident in the form of a color change from the typical white or transparent color of the polymer to a yellow, dark brown or black.

The degree of supercooling, in crystallization nucleation polymer studies, is important to obtain dependence of nano-nucleation that is proportional to the free energy of melting which is the driving force of nucleation. The degree of super cooling is defined as the difference of the polymers melt temperature and crystallization temperature. This is measured from a molten polymer temperature and the temperature which the polymer starts to crystallize. This difference ranges with different polymers. It is very close to zero for polyethylene and polypropylene, therefore these two polymers have a low degree of supercooling.

### SUMMARY OF THE INVENTION

The present invention allows for the processing of millions of pounds of plastic materials. The invention utilizes existing capital and mixed or pure plastics/polymers, and will dissolve molten or solid thermoplastic polymer/plastic near or above their glass transition temperature of individual polymer types or mixed plastics easily into a solvent. The practical use of the invention is to dissolve consumer plastics of mixed or separated varieties into various types of crude oil feedstock streams and to recycle these polymers through an existing or modified refinery cracker producing basic petro-chemicals, fuels, oils, lubricants and monomers for polymers.

In brief, an embodiment of the present invention comprises a method of modifying a polymer or plastic wherein a polymer system, comprising one or more polymer chains, is amorphous, crystalline, semi-crystalline or a combination thereof. The process includes exposing the polymer system in a solid, liquid or gas solvent such that the polymer system changes configuration or said polymer changes morphology. The process further comprises subjecting the polymer system to a thermodynamic mechanism such that the Gibbs Free Energy of the polymer system is lowered, the polymer system's entropy is increased, and its chain orientation or morphology is altered.

The present invention further comprises a method and/or process for the economic processing, recycling or reuse of polymers or plastics of a number of types, for example, polymers from prime, virgin, post-consumer, post-industrial or other sources. The present invention may be deployed by using the thermodynamic properties of the polymers or mixed polymer stream to ensure the polymer is above its glass transition temperature in order to minimize the system's Gibbs free energy to allow the polymer to easily be dissolved into a solvent. The polymer can be, but not necessarily be, at or above its melt temperature. The solvent can be at its Flory (Theta solvent) temperature but again not necessarily.

In an embodiment, the invention can be used for manufacturing a plastic object from its base polymer by first dissolving the polymer needed for the part in a solvent by introducing the polymer as a molten liquid and not a rigid solid into the solvent of desire.

In an embodiment of the invention, plastic material is fed into cat cracker or similar device to produce molecules of C₂-C₃₀ in size.

In an embodiment of the invention, plastic material is bled into crude oil as described above and then fed into cat cracker or similar device to produce molecules of C₂-C₃₀ in size.

In an embodiment of the invention, the dissolution method described above is followed by the reduction of the temperature of the solvent below Flory (Theta solvent) temperature and polymer is thus precipitated.

In an embodiment of the invention, the dissolution method described above is practiced and then a different solvent is added that the polymer does not find compatible and then polymer precipitated.

### DETAILED DESCRIPTION OF THE INVENTION

### Process Description (Including Feed Temperatures)

This process and the steps thereof relate to the use, for example, of high density polyethylene (HDPE) using a solid HDPE material originally at room temperature. The HDPE at room temperature is opaque and appears crystalline or semi-crystalline. No color was added to the HDPE. The solvent used is VGO (vacuum gas oil) that is originated from crude oil. VGO contains hydrocarbon material which is heavier than diesel or 350 IBP to 585 degrees Celsius end point. Its cracking temperature is near to 360 degrees Celsius.

An embodiment of the present invention comprising a method of modifying a polymer or plastic, wherein a polymer system, comprising one or more polymer chains, is amorphous, crystalline, semi-crystalline or a combination thereof, comprising exposing the polymer system in a solid, liquid or gas solvent such that the polymer system changes configuration or said polymer changes morphology and subjecting the polymer system to a thermodynamic mechanism such that the Gibbs Free Energy of the polymer system is lowered, the polymer system's entropy is increased, and its chain orientation or morphology is altered.

In an embodiment the method described and claimed herein comprises an organic solvent.

In an embodiment the method described and claimed herein comprises a polymer system used in connection with oil refining.

In an embodiment the method described and claimed herein comprises a polymer system used in connection with catalytic crude cracking.

An embodiment described and claimed herein comprises a polymer system used in connection with plastic production.

In an embodiment of the invention disclosed and claimed herein the method's polymer system is used in connection with polymer polymerization.

In an embodiment of the invention disclosed and claimed herein the method's polymer system is used in connection with plastic forming.

In an embodiment of the invention disclosed and claimed herein the altered polymer system is miscible in other systems of liquids, solvents, polymers, gases and other environments.

In an embodiment of the invention disclosed and claimed herein the thermodynamic mechanism is heat.

In an embodiment of the invention disclosed and claimed herein the thermodynamic mechanism is solvency.

In an embodiment of the invention disclosed and claimed herein the thermodynamic mechanism is theta solvency.

In an embodiment of the invention disclosed and claimed herein the thermodynamic mechanism is extrusion.

In an embodiment of the invention disclosed and claimed herein the thermodynamic mechanism is radiation.

In an embodiment of the invention disclosed and claimed herein the thermodynamic mechanism is solar.

In an embodiment of the invention disclosed and claimed herein the thermodynamic mechanism is melting.

In an embodiment of the invention disclosed and claimed herein the thermodynamic mechanism is physical working.

In an embodiment of the invention disclosed and claimed herein the thermodynamic mechanism is calendaring.

In an embodiment of the invention disclosed and claimed herein the thermodynamic mechanism is pumping.

In an embodiment of the invention disclosed and claimed herein the thermodynamic mechanism alters the polymer chain morphology.

In an embodiment of the invention disclosed and claimed herein the thermodynamic mechanism alters the polymer chain mobility.

In an embodiment of the invention disclosed and claimed herein the polymer orientation is defined by the polymer's atomic or chemical bonds.

In an embodiment of the invention disclosed and claimed herein the polymer orientation is defined by chain to chain polymer interactional structure.

In an embodiment of the invention disclosed and claimed herein the polymer orientation is defined by polymer morphology.

In an embodiment of the invention disclosed and claimed herein an altered polymer structure allows the polymer chain to be compatible with other molecules.

In an embodiment of the invention disclosed and claimed herein an altered polymer structure reduces the polymer system's Gibbs free energy and increases the polymer system's entropy.

An embodiment of the invention disclosed and claimed herein causes the polymer to dissolve in other molecules.

An embodiment of the invention disclosed and claimed herein causes the polymer to be compatible with other molecules.

In an embodiment of the invention disclosed and claimed herein one or more of the polymer chains is amorphous.

In an embodiment of the invention disclosed and claimed herein one or more of the polymer chains is crystalline.

In an embodiment of the invention disclosed and claimed herein one or more of the polymer chains is semi-crystalline.

In an embodiment of the invention disclosed and claimed herein one or more of the polymer chains comprises a combination of both amorphous and crystalline polymers.

In an embodiment of the invention disclosed and claimed herein a method of modifying a polymer or plastic, wherein a polymer system, comprising one or more polymer chains, is amorphous, crystalline, semi-crystalline or a combination thereof, comprises exposing the polymer system in a solid, liquid or gas solvent such that the polymer system changes configuration or said polymer changes morphology; and further comprises subjecting the polymer system to a thermodynamic mechanism that treats the polymer such that the Gibbs Free Energy of the polymer system is lowered, the polymer system's entropy is increased, and its chain orientation or morphology is altered. Variations on this embodiment include wherein the thermodynamic treatment is physical, mechanical, melting, physical working, calendaring, physical treatment, pumping, or solar exposure.

In an embodiment of the invention disclosed and claimed herein the thermodynamic treatment increases the polymer's molecular entropy.

In an embodiment of the invention disclosed and claimed herein the thermodynamic treatment increases the polymer system's entropy.

In an embodiment of the invention disclosed and claimed herein the thermodynamic treatment alters the polymer to polymer chain orientation.

An embodiment of the invention disclosed and claimed herein comprises transferring a polymer system that is stable and in a solvent or additive into a chemical or mechanical process.

An embodiment of the invention disclosed and claimed herein comprises transferring said polymer system into an oil refining process.

An embodiment of the invention disclosed and claimed herein comprises transferring said polymer system into a crude catalytic cracking process.

An embodiment of the invention disclosed and claimed herein comprises transferring said polymer system into a film production process.

An embodiment of the invention disclosed and claimed herein comprises transferring said polymer system into a plastic molding process.

An embodiment of the invention disclosed and claimed herein comprises transferring said polymer system into a film casting process.

An embodiment of the invention disclosed and claimed herein comprises transferring said polymer system into an extrusion process.

An embodiment of the invention disclosed and claimed herein comprises transferring said polymer system into a stream of crude oil or other feed stream components.

In an embodiment of the invention disclosed and claimed herein said processes take place in a refinery cracker or similar equipment.

In an embodiment of the invention disclosed and claimed herein said processes take place in a refinery cracker or similar equipment.

In an embodiment of the invention disclosed and claimed herein said processes take place take place in refinery or similar equipment that produces petroleum products.

In an embodiment of the invention disclosed and claimed herein said processes take place in refinery or similar equipment produces organic based chemicals.

In an embodiment of the invention disclosed and claimed herein said processes take place in refinery or similar equipment that produces monomers for polymers.

In an embodiment of the invention disclosed and claimed herein said plastics are mixed, laminated or multi-layer materials.

An embodiment of the invention disclosed and claimed herein comprises a method of changing or maintaining a polymer system's stability comprising using as a baseline the system's Flory Theta temperature.

The plastics (a mixture of polymers either of the same or different type polymers) are received from a source as mentioned above. The plastic is then size reduced if needed by shredding, grinding, milling or size reducing methods. The plastics are melted through either an extruder, calendar, melt pump or other heat source. The molten plastic is then mixed with one of the solvents mentioned below, either through a mix tank, or in-line mixing system. The percent of plastic added for the ratio of plastic to solvent can range from 0-80 percent, depending on the type of polymer and type of solvent. The system of the solution containing both plastics and solvent should be maintained at a temperature above theta temperature (or Flory temperature) or degree of supercooling temperature which should be above the polymer's glass transition temperature (Tg) of the polymer/s.

Once the polymer is in the solvent creating a single solution, this solution can be:

a.) Pumped into a Cat Cracker (Fluid Catalytic Cracker—FCC) and turned back into monomer or other refinery products.

b.) The pure polymer can be separated from the multi-polymer mixture. This can be achieved by precipitating the polymer from the solution using the Theta Flory temperature conditions for individual polymer and solvents.

c.) The polymer can be separated through precipitation using the degree of supercooling temperatures or theta temperatures.

d.) The polymer can be separated by introducing a different solvent or combination of solvents and using Theta Flory temperature or super cooling temperatures.

e.) The polymers can be purified by the means outlined in section (d) [CHECK] to create a virgin polymer.

f.) The solvent-polymer system can be cast, spun, pumped, extruded or molded to produce a final product using temperature techniques, such as reducing the temperature of the mixture until one or any polymer precipitates out of the solution.

### Solvent Types

Generally, solvents that would allow an amorphous or semi/crystalline polymer molten or solid polymer to be dissolved within should be used and considered. The mixture can be miscible meaning clear, or compatible meaning cloudy but good enough for blending. Solvents of non-polar type/natural would be better; non polar solvents contain bonds between atoms with similar electronegativities, such as carbon and hydrogen (most hydrocarbons, such as gasoline).

### Solvent Types for Use in the Present Invention

Generally, solvents that would allow an amorphous or semi/crystalline polymer to be dissolved in. The mixture can be miscible meaning clear, or a compatible cloudy mixture that is good enough for blending.
Solvents of non-polar type/natural are advantageous. Non polar solvents contain bonds between atoms with similar electronegativities, such as carbon and hydrogen (for example, hydrocarbons, such as gasoline).
Specific solvent examples:
   Crude oil.
   Vacuum Gas Oil (VGO): a feedstock purchased by refineries of lighter molecular weights to feed the FCC (Fluid Catalytic Cracker—referred as Cat Cracker.
   Pyrolysis gas oil (PGO)
   Light fuel oil (LFO)
   Organic feedstocks: xylene, toluene, napthalene, benzene, and other solvents.

### Polymer Solvent Roles and Characteristics

Most, if not all, research takes solid polymer/s and dissolves them into a room temperature solvent. If needed, heat can be added to the solution of polymer and solvent to enhance the dissolving. However, there appears to be no research for adding melted polymer to a solvent. By way of example, the literature shows:
   Semi/Crystalline polymers are difficult to get into solution since the solvent must get into—attack the crystalline lattice structure
   Role of the solvent: it has been known but not widely studied that polymer/solvent solutions have varied solubilities at different temperatures.
   Polymer solutions occur in two stages. Initially, the solvent molecules diffuse through the polymer matrix to form a swollen, solvated mass called a gel. In the second stage, the gel breaks up and the molecules are dispersed into a true solution. Not all polymers can form true solution in solvent.
   For a polymer to dissolve into a solvent the system needs a high Entropy.
   For a polymer to dissolve in a solvent the system needs a negative Gibbs Free Energy.
   A melted polymer is amorphous and free to move since it is a liquid yielding higher Entropy and negative Gibbs Free Energy than when in the solid phase.
   Since a melted polymer is flowable it is easy to process by pump, eliminating dust.
   Solubility properties vary with temperature in a given solvent. For a given solid polymer which is dissolved in a solvent, the lowest temperature at which the solution is stable is called the theta temperature (or Flory temperature), and the solvent is then called a theta solvent. Additionally, the polymer is said to be in a theta state. In the theta state, the polymer is on the brink of becoming insoluble; in other words, the solvent is having a minimal solvation effect on the dissolved molecules. Any further diminishment of this effect (example decrease in temperature or lower solvent concentration in the solution) causes the attractive forces among polymer molecules to predominate, and the polymer precipitates, meaning the polymer chains prefers its own chemical structure instead of the solvent and then collapses onto itself and forms a solid that precipitates.

### Polymer Examples

There are a number of polymer examples for use in the present invention:
Polyethylene
Polypropylene
Poly-ethylene-terephthalate
Poly-Styrene
Poly-vinyl chloride
Poly-Carbonate
Nylon
Polyesters
Rubber
All thermoplastic polymers

### Sources of Feedstocks

There are a number of example feed stocks:
Post consumer
Post industrial
Waste
Garbage from curbside
Garbage from trash transfer stations
Ocean debris
Landfills
Plastic recycling centers
Haulers of waste containers
From individual homes
All other sources of plastic material either waste or other
Materials Recycling Facility (MRF)

### Types of Materials for Recycling In the Present Invention

Plastic bottles
Plastic films
Plastic garbage bags
Plastic shopping bags
Multi-layer bottles, films and bags
Mixed household plastics
Packaging from items such as
Fruit containers
Plastic from pretzels, potato chip, other bags/packages
Juice containers single and multi-layer plastic
Pouches: plastic film, Capri Sun, Baby food, others
Wraps from meats
Foam shipping materials (Styro-foam)
Bubble packaging
Amazon, US Postal, and other padded envelopes
Shrink film from commercial, industry, home
Freezer plastic wrap films (meats, fish, etc.)
Cosmetic containers and packaging
Household cleaner packaging and bottles
Health and beauty aids; bottles, packaging and containers
Packages of laminated plastic to paper (TetraPak juice/milk cartons)
Labels from packages of plastic or plastic and paper
Possibly cotton-polyester blends, for example, mattresses, clothing, bedding, towels, etc.

### Properties of Polymers for Dissolution In the Present Invention

Glass Transition Temperature: Tg, the temperature below which a polymer is brittle or glass-like; at this temperature the polymer chain has no molecular motion.
Melt Temperature: the temperature at which the solid plastic melts into a liquid and is processible. In the literature this may be called the Semi/or Crystalline melt temperature, where the crystal melts into the amorphous molten state.
Morphology: the polymer chain orientation/structure such as crystalline, semi crystalline, amorphous—can be solid or molten (random polymer chains no order).
Crystalline/Semi-Crystalline Solid Polymer): the structure (morphology) in the solid crystalline polymers are generally semi-crystalline, examples: Polyethylene, PolyPropylene, PET, Nylons, and polymers that exhibit a region of crystallinity
Amorphous in Solid Polymer: Polymers with no crystallinity or no order; examples: PolyStyrene, PVC, Poly-Carbonate, Styrene-Acrylonitrile, Acrylohitrile-Butadiene-Stryrene, Poly-Methyl-Methacrylate, Poly-butadiene, and other polymers that have no long range order.
Crystalline Melt Temperature: The temperature a semi/crystalline polymers melts and its morphology changes to amorphous (also the liquid melt temperature) from semi/crystalline.
Amorphous structure in melt phase: most polymers in the melted, free flowing phase are amorphous, totally random, meaning they have no polymer structure. An exception would be special liquid crystal polymers for special uses, and very expensive.

### Process Description

The plastics (a mixture of polymers either of the same or different) are received from a source as mentioned above, the plastic is then size reduced if needed by shredding, grinding, pulverizing, milling, size reducing.
The plastics are melted through either an extruder, calendar, melt pump or heated tank.
The molten plastic is then mixed with one of the solvents mentioned above. Either through a mix tank, or in-line mixing system.
The percent of plastic added for the ratio of plastic to solvent needs to be determined for each mixture and application from 1 to 80 percent.
The system of the solution containing both plastics and solvent should be maintained at a temperature above theta temperature (or Flory temperature) which should be above the polymer's glass transition temperature (Tg) of the polymer/s
Once the polymer is in the solvent creating a single solution, this solution can be pumped into a Cat Cracker (Fluid Catalytic Cracker—FCC) and turned back into monomer or other refinery products.
One can separate the pure polymer from the multi-polymer mixture. This can be achieved by precipitating the polymer from the solution using the Theta Flory temperature conditions for individual polymer and solvents.
The polymer can be separated through precipitating using the degree of supercooling temperatures.
The polymer can be separated introducing a different solvent or combination of solvents and using Theta Flory temperature or super cooling temperatures.
The polymers can be purified by these means to create a virgin polymer.
The solvent-polymer system can be cast, spun, pumped, extruded or molded to produce a final product using the temperature techniques.

### EXAMPLES

The following examples are for illustrative purposes and are not intended to limit the scope and content of the claims or the specification.

### Example 1

### Poly-Propylene

This Example comprises a process and the steps thereof that relate to the use of polypropylene using a solid polypropylene material originally at room temperature. The polypropylene at room temperature is opaque and appears crystalline or semi-crystalline. The solvent used is VGO (vacuum gas oil) that is originated from crude oil. VGO contains hydrocarbon material which is heavier than diesel or 350 IBP to 585 degrees Celsius end point. Its cracking temperature is near to 360 degrees Celsius.

The following is an example of the method used in practicing a recovery and recycling process:
1. The polypropylene is heated to 176 degrees Celsius and melted.
2. The melted polypropylene appears clear.
3. The clear appearance of the polypropylene confirms no crystallinity.
4. The clear appearance exhibits the polymer is amorphous.
5. This exhibits the polymer has increased its available special configurations increasing the Entropy and decreasing the Gibbs Free Energy.
6. The VGO is heated to 125 degrees Celsius.
7. The VGO is stirred.
8. The molten polypropylene is added to the VGO.
9. At various concentrations of 0-40 percent polypropylene goes into or is dissolved in the VGO.
10. This exhibits a furthering of the available polymer configurations and therefore greater increasing the Entropy and further reducing the Gibbs Free Energy.

### Example 2

### Poly-Ethylene High Density—(HDPE)

The following is an example of the method used in practicing this recovery and recycling process:

1.) The HDPE is heated to 255 degrees Celsius and melted.

2.) The melted HDPE appears clear.

3.) The clear appearance of the HDPE confirms no crystallinity.

4.) The clear appearance exhibits the polymer is amorphous.

5.) This exhibits the polymer has increased its available special configurations increasing the Entropy and decreasing the Gibbs Free Energy.

6.) The VGO is heated to 125 degrees Celsius.

7.) The VGO is stirred.

8.) The molten HDPE is added to the VGO.

9.) At various concentrations of 0-38 percent HDPE goes into or dissolves in the VGO.

10.) This exhibits a furthering of the available polymer configurations and therefore greater increasing the Entropy and further reducing the Gibbs Free Energy.

### Example 3

### Polypropylene (Solid) Mixed with Polyethylene (HDPE) Solid; 50/50 (PP-HDPE)

This process and the steps thereof relate to the use of PP-HDPE using a solid PP-HDPE material originally at room temperature. The PP-HDPE at room temperature is opaque and appears crystalline or semi-crystalline. The two polymers are physically mixed. The solvent used is VGO (vacuum gas oil) that is originated from crude oil. VGO contains hydrocarbon material which is heavier than diesel or 350 IBP to 585 degrees Celsius end point. Its cracking temperature is near to 360 degrees Celsius.

The following is an example of the method used in practicing this recovery and recycling process:

1.) The PP-HDPE solid mixture is heated to 270 degrees Celsius and melted.

2.) The melted PP-HDPE appears clear.

3.) The clear appearance of the PP-HDPE confirms no crystallinity.

4.) The clear appearance exhibits the polymer is amorphous.

5.) This exhibits the polymer has increased its available special configurations increasing the Entropy and decreasing the Gibbs Free Energy.

6.) The VGO is heated to 125 degrees Celsius.

7.) The VGO is stirred.

8.) The molten PP-HDPE is added to the VGO.

9.) At various concentrations of 0-47 percent of total polymers of a mixture of high density polyethylene and poly-propylene goes into or dissolves in VGO.

10.) This exhibits a furthering of the available polymer configurations and therefore greater increasing the Entropy and further reducing the Gibbs Free Energy.

### Example 4

### Poly-Propylene with Polyethylene Laminated Film (PP-HDPE Film)

This process and the steps thereof relate to the use of PP-HDPE film using a solid PP-HDPE material originally at room temperature. The PP-HDPE at room temperature appears crystalline or semi-crystalline. The solvent used is VGO (vacuum gas oil) that is originated from crude oil. VGO contains hydrocarbon material which is heavier than diesel or 350 IBP to 585 degrees Celsius end point. Its cracking temperature is near to 360 degrees Celsius.

The following is an example of the method used in practicing this recovery and recycling process:

1.) The PP-HDPE is heated to 280 degrees Celsius and melted.

2.) The melted PP-HDPE appears clear.

3.) The clear appearance of the PP-HDPE confirms no crystallinity.

4.) The clear appearance exhibits the polymer is amorphous.

5.) This exhibits the polymer has increased its available special configurations increasing the Entropy and decreasing the Gibbs Free Energy.

6.) The VGO is heated to 125 degrees Celsius.

7.) The VGO is stirred.

8.) The molten PP-HDPE is added to the VGO.

9.) At various concentrations of 0-40 percent total polymers of a mixture of high density polyethylene and poly-propylene go into or dissolve in the VGO.

10.) This exhibits a furthering of the available polymer configurations and therefore greater increasing the Entropy and further reducing the Gibbs Free Energy.

### Example 5

### Polypropylene Dissolved in Xylene and Added to VGO

This process and the steps thereof relate to the use of poly-propylene using a solid poly-propylene material originally at room temperature. The polypropylene at room temperature is opaque and appears crystalline or semi-crystalline. The first solvent used is Xylene. The second solvent used is VGO (vacuum gas oil) that is originated from crude oil. VGO contains hydrocarbon material which is heavier than diesel or 350 IBP to 585 degrees Celsius end point. Its cracking temperature is near to 360 degrees Celsius.

The following is an example of the method used in practicing this recovery and recycling process:
1. The polypropylene is at room temperature.
2. The Xylene is heated to 125 degrees Celsius.
3. The polypropylene is added to the Xylene.
4. The clear appearance of the solution of xylene-polypropylene confirms no crystallinity.
5. The clear appearance exhibits the polymer is amorphous and random in the solution.
6. This exhibits the polymer has increased its available special configurations increasing the Entropy and decreasing the Gibbs Free Energy.
7. The VGO is room temperature.
8. The VGO is stirred.
9. The solution of the xylene and polypropylene are added to the VGO.
10. At various concentrations of 0-25 percent poly-propylene go into or dissolve in the VGO.
11. This exhibits a furthering of the available polymer configurations and therefore greater increasing the Entropy and further reducing the Gibbs Free Energy.
   The procedures of the Examples were repeated with VGO at room temperature using molten polymers as described above. All repeated Examples worked substantially the same with substantially the same results achieved at first.

### Example 6

### Poly-Propylene

This process and the steps thereof relate to the use of polypropylene using a solid polypropylene material originally at room temperature. The polypropylene at room temperature is opaque and appears crystalline or semi-crystalline. The solvent used is VGO (vacuum gas oil) that is originated from crude oil. VGO contains hydrocarbon material which is heavier than diesel or 350 IBP to 585 degrees Celsius end point. Its cracking temperature is near to 360 degrees Celsius.

The following is an example of the method used in practicing this recovery and recycling process:

1.) The polypropylene is heated to 176 degrees Celsius and melted.

2.) The melted polypropylene appears clear.

3.) The clear appearance of the polypropylene confirms no crystallinity.

4.) The clear appearance exhibits the polymer is amorphous.

5.) This exhibits the polymer has increased its available special configurations increasing the Entropy and decreasing the Gibbs Free Energy.

6.) The VGO is heated to 125 degrees Celsius.

7.) The VGO is stirred.

8.) The molten polypropylene is added to the VGO.

9.) At various concentrations of 0-40 percent poly-propylene goes into or dissolves in the VGO.

10.) The mixture of dissolved polymer and solvent are kept above the Flory Theta temperature and pumped as a Newtonian fluid.

11.) This exhibits a furthering of the available polymer configurations and therefore greater increasing the Entropy and further reducing the Gibbs Free Energy.

### Example 7

### Poly-Ethylene High Density—(HDPE)

This process and the steps thereof relate to the use of high density polyethylene (HDPE) using a solid HDPE material originally at room temperature. The HDPE at room temperature is opaque and appears crystalline or semi-crystalline. No color was added to the HDPE. The solvent used is VGO (vacuum gas oil) that is originated from crude oil. VGO contains hydrocarbon material which is heavier than diesel or 350 IBP to 585 degrees Celsius end point. Its cracking temperature is near to 360 degrees Celsius.

The following is an example of the method used in practicing this recovery and recycling process:
1. The HDPE is heated to 255 degrees Celsius and melted.
2. The melted HDPE appears clear.
3. The clear appearance of the HDPE confirms no crystallinity.
4. The clear appearance exhibits the polymer is amorphous.
5. This exhibits the polymer has increased its available special configurations increasing the Entropy and decreasing the Gibbs Free Energy.
6. The VGO is heated to 125 degrees Celsius.
7. The VGO is stirred.
8. The molten HDPE is added to the VGO.
9. At various concentrations of 0-38 percent HDPE go into or dissolve in the VGO.
10. The mixture of dissolved polymer and solvent are kept above the Flory Theta temperature and pumped as a Newtonian fluid.
11. This exhibits a furthering of the available polymer configurations and therefore greater increasing the Entropy and further reducing the Gibbs Free Energy.

### Example 8

### Polypropylene (Solid) Mixed with Polyethylene (HDPE) Solid; 50/50 (PP-HDPE)

This process and the steps thereof relate to the use of PP-HDPE using a solid PP-HDPE material originally at room temperature. The PP-HDPE at room temperature is opaque and appears crystalline or semi-crystalline. The two polymers are physically mixed. The solvent used is VGO (vacuum gas oil) that is originated from crude oil. VGO contains hydrocarbon material which is heavier than diesel or 350 IBP to 585 degrees Celsius end point. Its cracking temperature is near to 360 degrees Celsius.
The following is an example of the method used in practicing this recovery and recycling process:

1. The PP-HDPE solid mixture is heated to 270 degrees Celsius and melted.

2. The melted PP-HDPE appears clear.

3. The clear appearance of the PP-HDPE confirms no crystallinity.

4. The clear appearance exhibits the polymer is amorphous.

5. This exhibits the polymer has increased its available special configurations increasing the Entropy and decreasing the Gibbs Free Energy.

6. The VGO is heated to 125 degrees Celsius.

7. The VGO is stirred.

8. The molten PP-HDPE is added to the VGO.

9. At various concentrations of 0-47 percent of the total combine polymers of high density polyethylene and poly-propylene goes into or dissolves in VGO.

10. The mixture of dissolved polymer and solvent are kept above the Flory Theta temperature and pumped as a Newtonian fluid.

11. This exhibits a furthering of the available polymer configurations and therefore greater increasing the Entropy and further reducing the Gibbs Free Energy.

### Example—9

### Poly-Propylene with Polyethylene Laminated Film (PP-HDPE Film)

This process and the steps thereof relate to the use of PP-HDPE film using a solid PP-HDPE material originally at room temperature. The PP-HDPE at room temperature appears crystalline or semi-crystalline. The solvent used is VGO (vacuum gas oil) that is originated from crude oil. VGO contains hydrocarbon material which is heavier than diesel or 350 IBP to 585 degrees Celsius end point. Its cracking temperature is near to 360 degrees Celsius.

The following is an example of the method used in practicing this recovery and recycling process:
1. The PP-HDPE is heated to 280 degrees Celsius and melted.
2. The melted PP-HDPE appears clear.
3. The clear appearance of the PP-HDPE confirms no crystallinity.
4. The clear appearance exhibits the polymer is amorphous.
5. This exhibits the polymer has increased its available special configurations increasing the Entropy and decreasing the Gibbs Free Energy.
6. The VGO is heated to 125 degrees Celsius.
7. The VGO is stirred.
8. The molten PP-HDPE is added to the VGO.
9. At various concentrations of 0-40 percent total polymers of a mixture of high density polyethylene and poly-propylene into goes into or dissolves in the VGO.
10. The mixture of dissolved polymer and solvent are kept above the Flory Theta temperature and pumped as a Newtonian fluid.
11. This exhibits a furthering of the available polymer configurations and therefore greater increasing the Entropy and further reducing the Gibbs Free Energy.

### Example 10

### Polypropylene Dissolved in Xylene and Added to VGO

This process and the steps thereof relate to the use of polypropylene using a solid polypropylene material originally at room temperature. The polypropylene at room temperature is opaque and appears crystalline or semi-crystalline. The first solvent used is Xylene. The second solvent used is VGO (vacuum gas oil) that is originated from crude oil. VGO contains hydrocarbon material which is heavier than diesel or 350 IBP to 585 degrees Celsius end point. Its cracking temperature is near to 360 degrees Celsius.

The following is an example of the method used in practicing this recovery and recycling process:
1. The polypropylene is at room temperature.
2. The Xylene is heated to 125 degrees Celsius.
3. The polypropylene is added to the Xylene.
4. The clear appearance of the solution of xylene-polypropylene confirms no crystallinity.
5. The clear appearance exhibits the polymer is amorphous and random in the solution.
6. This exhibits the polymer has increased its available special configurations increasing the Entropy and decreasing the Gibbs Free Energy.
7. The VGO is room temperature.
8. The VGO is stirred.
9. The solution of the xylene and polypropylene are added to the VGO.
10. At various concentrations of 0-25 percent polypropylene goes into or dissolves in the VGO.
11. The mixture of dissolved polymer and solvent are kept above the Flory Theta temperature and pumped as a Newtonian fluid.
12. This exhibits a furthering of the available polymer configurations and therefore greater increasing the Entropy and further reducing the Gibbs Free Energy.

1. A method of modifying a polymer or plastic, wherein a polymer system, comprising one or more polymer chains, is amorphous, crystalline, semi-crystalline or a combination thereof, comprising:
exposing the polymer system in a solid, liquid or gas solvent such that the polymer system changes configuration or said polymer changes morphology;
subjecting the polymer system to a thermodynamic mechanism such that the Gibbs Free Energy of the polymer system is lowered, the polymer system's entropy is increased, and its chain orientation or morphology is altered.

2. The method of claim 1 wherein the solvent is an organic solvent.

3. The method of claim 1 wherein the polymer system is used in connection with oil refining.

4. The method of claim 1 wherein the polymer system is used in connection with catalytic crude cracking.

5. The method of claim 1 wherein the polymer system is used in connection with plastic production.

6. The method of claim 1 wherein the polymer system is used in connection with polymer polymerization.

7. The method of claim 1 wherein the polymer system is used in connection with plastic forming.

8. The method of claim 1 wherein the altered polymer system is miscible in other systems of liquids, solvents, polymers, gases and other environments.

9. The method of claim 1 wherein the mechanism is heat.

10. The method of claim 1 wherein the mechanism is solvency.

11. The method of claim 1 wherein the mechanism is theta solvency.

12. The method of claim 1 wherein the mechanism is extrusion.

13. The method of claim 1 wherein the mechanism is radiation.

14. The method of claim 1 wherein the mechanism is solar.

15. The method of claim 1 wherein the mechanism is melting.

16. The method of claim 1 wherein the mechanism is physical working.

17. The method of claim 1 wherein the mechanism is calendaring.

18. The method of claim 1 wherein the mechanism is pumping.

19. The method of claim 1 wherein the thermodynamic mechanism alters the polymer chain morphology.

20. The method of claim 1 wherein the thermodynamic mechanism alters the polymer chain mobility.

21. The method of claim 1 wherein the polymer orientation is defined by the polymer's atomic or chemical bonds.

22. The method of claim 1 wherein the polymer orientation is defined by chain to chain polymer interactional structure.

23. The method of claim 1 wherein the polymer orientation is defined by polymer morphology.

24. The method of claim 1 wherein an altered polymer structure allows the polymer chain to be compatible with other molecules.

25. The method of claim 1 wherein an altered polymer structure reduces the polymer system's Gibbs free energy and increases the polymer system's entropy.

26. The method of claim 1 wherein said method causes the polymer to dissolve in other molecules.

27. The method of claim 1 wherein said method causes the polymer to be compatible with other molecules.

28. The method of claim 1 wherein one or more of the polymer chains is amorphous.

29. The method of claim 1 wherein one or more of the polymer chains is crystalline.

30. The method of claim 1 wherein one or more of the polymer chains is semi-crystalline.

31. The method of claim 1 wherein one or more of the polymer chains comprises a combination of both amorphous and crystalline polymers.

32. A method of modifying a polymer or plastic, wherein a polymer system, comprising one or more polymer chains, is amorphous, crystalline, semi-crystalline or a combination thereof, comprising:
exposing the polymer system in a solid, liquid or gas solvent such that the polymer system changes configuration or said polymer changes morphology;
subjecting the polymer system to a thermodynamic mechanism that treats the polymer such that the Gibbs Free Energy of the polymer system is lowered, the polymer system's entropy is increased, and its chain orientation or morphology is altered.

33. The method of claim 32 wherein the thermodynamic treatment is physical.

34. The method of claim 32 wherein the thermodynamic treatment is mechanical.

35. The method of claim 32 wherein the thermodynamic treatment is melting.

36. The method of claim 32 wherein the thermodynamic treatment is physical working.

37. The method of claim 32 wherein the thermodynamic treatment is calendaring.

38. The method of claim 32 wherein the thermodynamic treatment is physical treatment.

39. The method of claim 32 wherein the thermodynamic treatment is pumping.

40. The method of claim 32 wherein the thermodynamic treatment is solar exposure.

41. The method of claim 32 wherein the treatment increases the polymer's molecular entropy.

42. The method of claim 32 wherein the treatment increase the polymer system's entropy.

43. The method of claim 32 wherein the treatment alters the polymer to polymer chain orientation.

44. A method of changing or maintaining a polymer system's stability comprising using as a baseline the system's Flory Theta temperature.

45. The method of claim 32 comprising transferring a polymer system that is stable and in a solvent or additive into a chemical or mechanical process.

46. The method of claim 45 wherein said process comprises transferring said polymer system into an oil refining process.

47. The method of claim 45 wherein said process comprises transferring said polymer system into a crude catalytic cracking process.

48. The method of claim 45 wherein said process comprises transferring said polymer system into a film production process.

49. The method of claim 45 wherein said process comprises transferring said polymer system into a plastic molding process.

50. The method of claim 45 wherein said process comprises transferring said polymer system into a film casting process.

51. The method of claim 45 wherein said process comprises transferring said polymer system into an extrusion process.

52. The method of claim 45 wherein said process comprises transferring said polymer system into a stream of crude oil or other feed stream components.

53. The method of claim 45 wherein said process takes place in a refinery cracker or similar equipment.

54. The method of claim 45 wherein said process takes place in a refinery cracker or similar equipment.

55. The method of claim 54 wherein said refinery or similar equipment produces petroleum products.

56. The method of claim 54 wherein said refinery or similar equipment produces organic based chemicals.

57. The method of claim 54 wherein said refinery or similar equipment produces monomers for polymers.

58. The method of claim 49 where said plastics are mixed, laminated or multi-layer materials.
